(19) United States
(12) Patent Application Publication
(10) Pub. No.: US 2009/0113806 A1
(43) Pub. Date: May 7, 2009

(54) Pesticide dust port

(75) Inventor: Arthur R. Manno, Weston, FL (US)

Correspondence Address: ROBERT M. DOWNEY, P.A., 6751 N. FEDERAL HWY., SUITE 300, BOCA RATON, FL, 33487, US

(73) Assignee: MSD Research, Inc.

(21) Appl. No.: 11/973,774

(22) Filed: Oct. 9, 2007

Related U.S. Application Data
(60) Provisional application No. 60/828,896, filed on Oct. 10, 2006.

(51) Int. Cl. E05D 7/00

(52) U.S. Cl. 49/402

(57) ABSTRACT

A device for providing closeable access through a ceiling, wall or floor and into an adjacent space, such as a crawl space or attic, includes a base flange surrounding an open portal and a cover plate attachable to the base flange for closing the open portal. The base flange mounts to the ceiling or wall with the open portal axially aligned with an opening previously formed through the ceiling or wall, wherein movement of the cover plate from the closed position permits access through the open portal and into the adjacent space. In a preferred embodiment, the cover plate is hingedly attached to the base flange to permit swinging movement between the closed and open positions. A pesticide dust can be conveniently applied to the adjacent space by inserting the wand end of a duster blower machine through the open portal. An angled adaptor, attachable to the wand end, allows 360° dispersal of the blown pesticide dust within the adjacent space.

This non-provisional patent application is based on provisional patent application Ser. No. 60/828,896 filed on Oct. 10, 2006.

### BACKGROUND OF THE INVENTION

1. Field of the Invention

This invention relates to devices that provide access through walls, ceilings or floors of a building structure and, more particularly, to a closeable access port including a base flange with an open portal and cover plate attachable to the base flange and movable between an open position to permit access through the portal and a closed position to cover the portal.

2. Discussion of the Related Art

Pest intrusion and infestation is a common problem in many houses and building structures. Pests such as, but not limited to, ants, termites, roaches, palmetto bugs, and rodents usually enter homes through vents, gaps, and other openings around the perimeter of the home structure. Typically, pests will nest and breed in attics, crawl spaces and within wall interiors. If not properly exterminated, a small infestation can quickly spread and become a serious problem to the homeowner and occupants of the dwelling.

Extermination of pests in attics, crawl spaces and other non-living areas of houses and building structures can be effectively accomplished by distributing a dry pesticide throughout the space. This powder or granular composition is specially formulated to provide lasting protection against specific species of pests, and is usually broadcast within the confined space with the use of a hand held blower machine, often referred to as a “dust blower” or “duster.” Commonly, this process is performed by a pest control service and requires a service person to enter the confined space. In many instances, where overhead clearances are low, service personnel must crawl to the far ends of the confined space, while dispersing the pesticide dust using the dust blower. This exposes the pest control service person to significant levels of dangerous chemicals in the confined space. Moreover, temperatures in attics and crawl spaces are often over 100 degrees Fahrenheit. And, because it is advisable to wear long pants and long sleeves to avoid skin contact with fiberglass insulation and the pesticide dust, the conditions in an attic or crawl space, particularly during the summer months can be extremely uncomfortable. Naturally, a person in this environment will find themselves soaked in perspiration by the time the job has been completed. This leads to a further problem, which is the inability to easily brush off the dust pesticide from one's skin, hair and clothing when wet with perspiration. Those who do this for a living will agree that a shower and a change of clothes is essential after completing a pesticide dusting in a hot attic or crawl space. This limits the number of jobs that can be performed by a pest control service person in a single day and, in turn, results in a loss of potential revenues to the pest control service company.

Accordingly, there remains an urgent need in the pest control industry for an access port device that allows a person to fully distribute a pesticide dust composition throughout the attic, crawl space or other confined space without having to physically enter the confined space.

### OBJECTS AND ADVANTAGES OF THE INVENTION

Considering the foregoing, it is a primary object of the present invention to provide a simple device that allows closeable access through a ceiling, wall or floor and into an adjacent space, such as a crawl space or attic.

It is a further object of the present invention to provide an access port device that allows easy and permanent access to attics, crawl spaces, and wall interiors, and wherein the access port device can be conveniently closed when not being used for access.

It is still a further object of the present invention to provide an access port device for providing easy, permanent and closable access to confined spaces such as attics, crawl spaces, and wall interiors, without having to physically enter the confined space.

It is still a further object of the present invention to provide an access port device that allows for passage of a wand of a pesticide dust blower into an attic, crawl space or other confined interior space of a building structure, thereby enabling distribution of a pesticide dust composition throughout the confined interior space without having to physically enter the confined space.

It is yet a further object of the present invention to provide an access port device, as described above, and which is particularly suited for passage of the end of a wand fitting of a pesticide dust blower, thereby allowing for easy, efficient, and thorough distribution of a dust pesticide product throughout a confined interior space, such as an attic or crawl space, without having to physically enter the confined space.

It is still a further object of the present invention to provide an access port device, as described above, that is relatively inexpensive, easy to install, easy to operate, low profile and cosmetically appealing.

These and other objects and advantages of the present invention are more readily apparent with reference to the detailed description and accompanying drawings.

### SUMMARY OF THE INVENTION

The present invention is directed to an access device for providing closeable access through a ceiling, wall or floor and into an adjacent space, such as a crawl space or attic. The access device includes a base flange surrounding an open portal and a cover plate attachable to the base flange for closing the open portal. The base flange mounts to the ceiling or wall with the open portal axially aligned with an opening previously formed through the ceiling or wall, wherein movement of the cover plate from the closed position to an open position permits access through the open portal and into the adjacent space. In a preferred embodiment, the cover plate is hingedly attached to the base flange to permit swinging movement between the closed and open positions.

The access port device is particularly useful for allowing distribution of a pesticide dust product throughout the adjacent space by inserting the end of a dust blower wand through the open portal. An angled adaptor attaches to the end of the dust blower wand to enhance 360 degree distribution of the pesticide dust product throughout an area of the adjacent space by simply turning the wand through a full rotation.

### BRIEF DESCRIPTION OF THE DRAWINGS

For a fuller understanding of the nature of the present invention, reference should be made to the following detailed description taken in conjunction with the accompanying drawings in which:

FIG. 1 is a top perspective view of the access port device of the present invention;

FIG. 2 is a top perspective view of an angled adaptor fitting for attachment to the wand end of a pesticide dust blower;

FIG. 3 is a side elevational view, in cross-section, showing installation of the access port device to an opening cut through the ceiling of a building structure, and wherein a cover plate of the device is shown in a closed position relative to a base flange and portal of the device, and further wherein the cover plate is shown in phantom lines to illustrate an open position of the cover plate; and

FIG. 4 is a side elevational view, in partial cross-section, showing an angled adaptor on the end of a dust blower wand passed through the open portal of the access port device of the present invention for dispersing a pesticide dust product throughout a 360 degree directional distribution in an attic or crawl space above the ceiling, and wherein a conventional pesticide dust blower machine is indicated in phantom lines.

Like reference numerals refer to like parts throughout the several views of the drawings.

### DETAILED DESCRIPTION OF THE PREFERRED EMBODIMENT

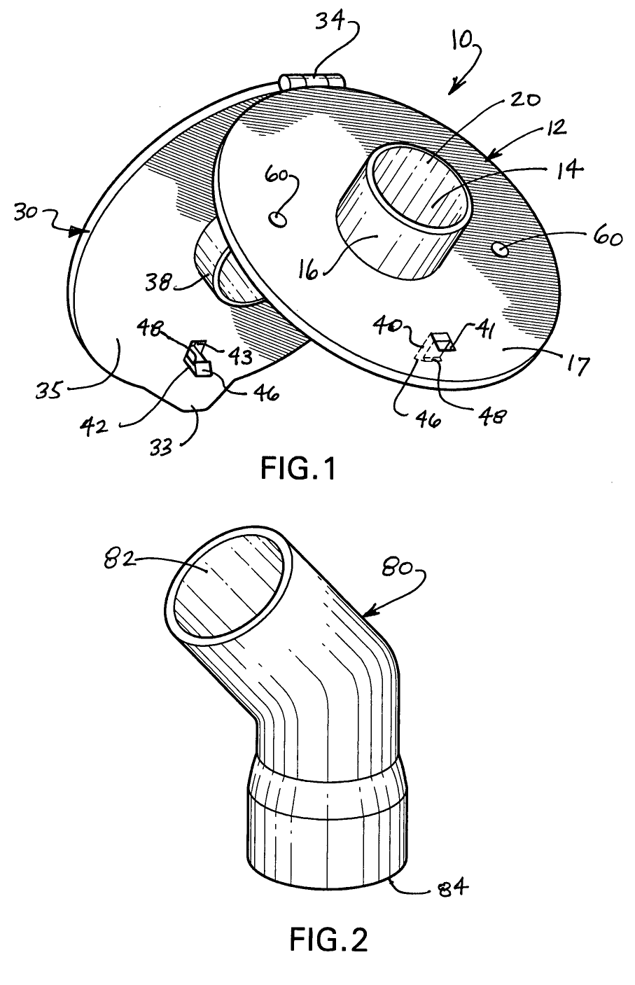

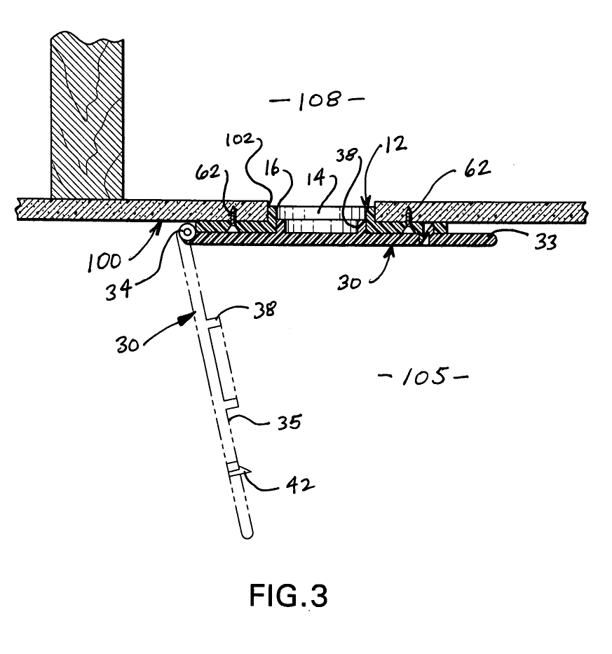

Referring to the several views of the drawings, and initially FIGS. 1 and 3, the access port device of the present invention is shown and is generally indicated as 10. The access port device 10 includes a base flange 12 with a central opening 14, defining an open portal. In a preferred embodiment, a sleeve 16 or wall structure extends from a top side 17 of the base flange 12 in surrounding relation to the portal opening 14, to thereby define an open top end 20 of the portal opening and an open bottom end 22 of the portal opening, with the sleeve 16 extending between the open top and bottom ends 20,22. It should be noted that the size and shape of the portal opening 14 and sleeve 16 may vary, and it is contemplated within the scope of the invention that the portal opening and sleeve may be round, square, rectangular, triangular or another shape. Moreover, the size of the portal opening 14 may be large enough to allow easy passage of a person's hand and arm therethrough. It is further contemplated that the portal opening may be of a size that is sufficient to allow passage of various devices (e.g. rat traps, mouse traps, spray canisters and dust blower wands) and other tools therethrough for placement and/or use and manipulation of these devices within a confined space (e.g. attic, crawl space, wall interior) while the user remains in the adjacent space on the opposite side of a wall, ceiling or floor structure.

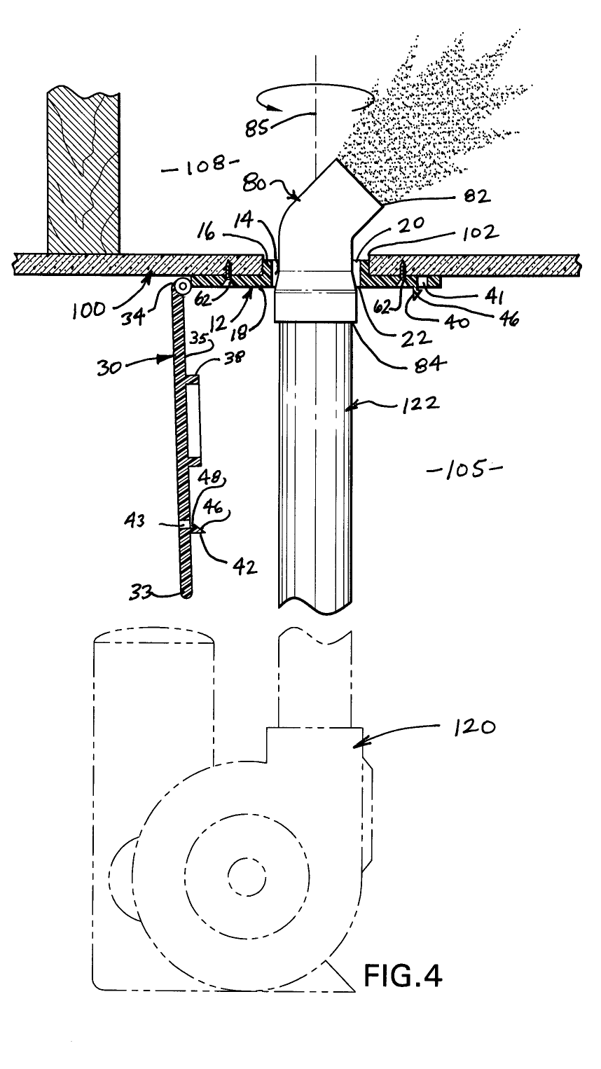

The access port device 10 further includes a cover plate 30 that is movably disposed in relation to the base flange 12 to both cover the bottom open end 22 of the portal opening 14, thereby closing the portal, and to uncover the bottom open end 22 of the portal opening to permit access through the portal opening 14 and into the adjacent space on the opposite side of the ceiling, wall or floor. In a preferred embodiment, the cover plate 30 is hingedly attached to the base flange 12 at hinge 34 to permit swinging movement of the cover plate 30 between the closed position (i.e., covering the portal opening) and the open position (as seen in FIGS. 1 and 4) to allow access through the portal opening 14. The hinged attachment of the cover plate 30 to the base flange 12 allows the cover plate to remain conveniently attached to the base flange, while further allowing for ease of movement of the cover plate 30 between the open and closed positions with a single hand.

In order to secure to the cover plate 30 in the closed position, in overlying relation to the bottom side 18 of the base flange 12 and covering the bottom end 22 of the portal opening 14, interlocking tabs are provided on both the base flange and the cover plate. As best seen in FIGS. 1 and 4, a first locking tab 40 extends downwardly from the bottom side 18 of the base flange 12 adjacent to a small opening 41 formed through the base flange. A second locking tab 42 extends upwardly from the top side 35 of the cover plate 30 and is correspondingly positioned and aligned for releasable, interlocking engagement with the first locking tab 40 on the base flange. A small opening 43 is formed through the cover plate adjacent to the second locking tab 42. More particularly, both the first locking tab 40 and the second locking tab 42 are provided with an angled surface 46 and abrupt shoulder 48 defining a catch surface. The angled surface 46 and catch surface 48 form a triangular head on the locking tabs. When the cover plate 30 is moved to the closed position, as seen in FIG. 3, the angled surfaces 46 of the locking tabs brush against each other. When the cover plate 30 is fully closed, the angled surfaces 46 of the locking tabs clear one another and the catch surfaces 48 of the locking tabs engage to hold the cover plate 30 in the closed position, as seen in FIG. 3, with the head of locking tab 40 received in opening 43 and the head of locking tab 42 received in opening 41. In order to open the cover plate 30, a protruding tongue 33 of the cover plate is pulled away from the base flange 12 with one or more fingers. By, applying a slight prying force, the locking tabs 40,42 separate and the cover plate 30 is allowed to swing about the axis of the hinge 34 to the open position.

In order to provide a complete closure of the portal opening 14, the top side 35 of the cover plate 30 is provided with a rim 38 that is congruently sized and configured for nested receipt within the bottom open end 22 of the portal opening 14, as seen in FIG. 3. Specifically, the outer dimension of the rim 38 is slightly smaller than the inner dimension of the portal opening, thereby allowing nested receipt of the rim 38 within the portal opening 14.

The access port device 10 is specifically structured for installation to a ceiling, wall or floor surface in relation to a hole or opening cut through the ceiling, wall or floor. When installed, the portal opening 14 is axially aligned with the opening in the ceiling, wall or floor and the base flange 12 is secured to the surface surrounding the opening.

FIGS. 3 and 4 demonstrate installation of the access port device 10 to a ceiling 100 separating a living space 105 from a crawl space 108 or attic above the ceiling. To install the access port device 10, the user must first locate a suitable area for installation (e.g., a closet, storage room, hallway, etc.) that provides at least 6 inches of clearance from any obstructions (e.g., studs, beams, trusses, wires, etc.) within the attic, crawl space or other confined space where access is desired. Next, a hole must be cut or drilled through the mounting surface. For example, in FIGS. 3 and 4, a hole 102 must be cut through the ceiling 100 prior to mounting the access port device 10 to the ceiling. The hole 102 cut through the ceiling 100 must be slightly larger than the outer dimensions of the sleeve 16 extending upwardly from the top side 17 of the base flange 12. Next, the base flange 12 is mounted to the ceiling surface so that the sleeve 16 on the top side of the base flange 12 is received within the opening 102 cut in the ceiling 100. A properly sized opening will allow the sleeve 16 on the base flange to nest neatly within the opening 102, as seen in FIGS. 3 and 4, with little to no gap between the edge of the opening 102 and the outer side surface of the sleeve 16. In a preferred embodiment, the base flange 12 is provided with at least 2 holes 60 formed therethrough for passage of screw fasteners 62. This allows the base flange 12 to be mounted to the ceiling surface with the use of screw fasteners 62 that extend into the ceiling, as seen in FIGS. 3 and 4. Alternatively, the base flange 12 may be mounted to the ceiling surface with double-sided tape between the top side of the base flange 12 and the ceiling surface, or by use of a suitable adhesive. Other well known means of mounting, such as nails, are contemplated as well.

The access port device 10 of the present invention is particularly suited for application of a dust pesticide product within a confined space, such as an attic, crawl space or wall interior, without requiring the person applying the pesticide dust product to physically enter the confined space. More particularly, the open portal 14 of the device 10 is sized, structured and disposed to accommodate passage of the end of a tube or wand 122 of a conventional pesticide dust blower (duster) machine 120, so that the pesticide dust product can be blown and distributed throughout an area surrounding the portal opening 14 within the confined space 108.

The present invention provides an angled adaptor fitting 80 that removably attaches to the end of the wand of the conventional pesticide dust blower. The angled adaptor 80 is sized and configured to fit through the open portal 14 and into the adjacent confined space 108 while the user operates the dust blower machine 120 in the adjacent living space 105 on the opposite side of the ceiling 100 or wall. In a preferred embodiment, the angled adaptor 80 includes an open top end 82 that is angled approximately 45 degrees relative to the axis 85 of the opposite open end 84 of the adaptor 80 and the attached wand 122 of the pesticide dust blower 120. The angled orientation of the open top end 84 of the adaptor allows for distribution of the pesticide dust product throughout an area surrounding the portal opening 14. By turning the wand about a full 360° rotation during application, the pesticide dust product can be disbursed throughout a 360 degree directional application to cover a large area surrounding the portal opening. After application, the wand 122 and adaptor 80 are removed from the portal opening 14 and the cover plate 30 is secured closed to cover the portal opening as shown in FIG. 3.

In many homes, it may be necessary to install multiple access port devices 10 at different locations throughout the home in order to provide full access to confined spaces for complete application pesticides or other products.

While the present invention has been shown and described in accordance with preferred and practical embodiments thereof, it is recognized that departures from the instant disclosure are fully contemplated within the spirit and scope of the invention.

What is claimed is:

1. A device for providing access through an opening in a structure separating two adjacent spaces, said device comprising:
a base flange having a bottom side and a top side, and said base flange including a central opening defining a portal surrounded by said base flange, and said top side being structured and disposed for fixed mounting to a surface of the separating structure so that said portal is aligned with the opening in the structure in open communication between the adjacent spaces, and said portal being sized, structured and disposed to permit access through said portal and said aligned opening in the separating structure;
a cover plate movably positionable relative to said bottom side of said base flange between an open position to permit access through said portal and a closed position to cover said portal and block access through said portal; and
said base flange and said cover plate being structured for interlocked releasable attachment of said cover plate to said base flange in said closed position.

2. The device as recited in claim 1 wherein said cover plate is hingedly attached to said base flange for permitting hinged movement of said cover plate between said open and closed positions.

3. The device as recited in claim 1 further comprising:
a hinge formed on said base flange and said cover plate for hinged attachment of said cover plate to said base flange, and said hinge being structured and disposed for allowing movement of said base plate between the open and closed positions.

4. The device as recited in claim 1 further comprising:
a rigid sleeve extending upwardly from said top side of said base flange in surrounding relation to said portal, and said rigid sleeve being structured and disposed for receipt within the opening in the separating structure.

5. The device as recited in claim 1 wherein said cover plate includes a top side for mating engagement with said bottom side of said base flange when said cover plate is in said closed position, and said top side of said cover plate further including a rim extending upwardly therefrom, and said rim being sized, structured and configured for receipt within said portal when said cover plate is in said closed position.
